(19) United States
(12) Patent Application Publication
(10) Pub. No.: US 2008/0220766 A1
(43) Pub. Date: Sep. 11, 2008

(54) Method for Control of Radio Measurements in a Cellular Mobile Radio Communication System

(75) Inventors: Ghislaine Bertho, Versailles (FR); Stanislas Bourdeaut, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/909,615

(22) PCT Filed: Mar. 21, 2006
(86) PCT No.: PCT/FR2006/050242

§ 371 Date: Mar. 6, 2008

(30) Foreign Application Priority Data
Mar. 25, 2005 (FR) 0503007

(51) Int. Cl. H04Q 7/20

(52) U.S. Cl. 455/423

(57) ABSTRACT

One aspect of the present invention is a method for radio measurement control in a cellular mobile radio communication system, for a mobile station in connected mode and in a mobility management state in which the mobile station effects cell reselection, said method including the steps of:
reception (1) by the mobile station of a dedicated radio measurement control message including radio measurement control information including measurement type control information, said measurement type being chosen in a group including intra-frequency measurements, inter-frequency measurements, inter-RAT (radio access technology) measurements,
configuration (2) of the mobile station for the execution of radio measurements in accordance with the radio measurement control information received in said message,
execution (3) of radio measurements by the mobile station in accordance with said configuration.

The present invention relates generally to mobile radio communication systems.

Mobile radio communication systems are generally covered by standards, and for a complete description of these systems the corresponding standards published by the corresponding standards organizations may be referred to.

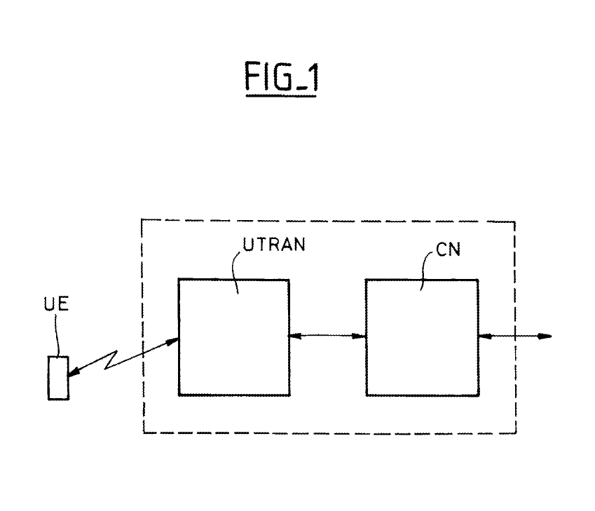

The general architecture of a mobile radio communication system such as a UMTS (Universal Mobile Telecommunication System) type system in particular is outlined in FIG. 1. The system includes a mobile radio communication network communicating with mobile terminals or UE (User Equipment) and with external networks (not specifically shown).

The mobile radio communication network includes:
a radio access network or UTRAN (UMTS Terrestrial Radio Access Network),
a core network CN.

Third generation systems, in particular of UMTS (Universal Mobile Telecommunication System) type, use a radio access technology of W-CDMA (Wideband—Code Division Multiple Access) type. The UTRAN includes base stations (each of which is called a Node B) and base station controllers or radio network controllers (RNC). The UTRAN communicates on the one hand with the mobile terminals UE, via an interface called the “Uu” interface (or radio interface), and on the other hand with the CN via an interface called the “Iu” interface. In the UTRAN, the Node B base stations communicate with the base station controllers RNC via an interface called the “Iub” interface, and an interface called the “Iur” interface can further be provided between RNCs.

Certain aspects of radio resource control used in the UTRAN are outlined briefly hereinafter. For a more complete description, see for example the 3GPP Technical Specification TS 25.331 defining the RRC (Radio Resource Control) protocol and published by the 3GPP (3rd Generation Partnership Project).

For optimized management of the radio resources, the RNC executes certain mobility management functions. Mobility management algorithms have therefore been defined in the UTRAN, based on a system of states called RRC states and transitions between those states.

There are two possible modes for a UE:
a mode called the “idle mode”, in which there is no connection between the UE and the UTRAN, and the UTRAN has no information on the location of the UE,
a mode called the “connected” mode, in which there is a connection between the UE and the UTRAN, and the UTRAN holds information on the location of the UE.

In the connected mode, various possible states of a UE are distinguished:
a state called the “Cell_DCH” state (where DCH stands for “Dedicated Channel”), in which the UTRAN knows that the UE is located in one or more cells called active cells, the UE effecting radio measurements and reporting the results of those measurements to the network,
a state called the “Cell_FACH” state (where FACH stands for “Forward Access Channel”), in which the UTRAN knows that the UE is located in a cell, the UE effecting radio measurements and itself effecting cell reselection on the basis of the results of these measurements and informing the network thereof by means of a cell update procedure,
a state called the “Cell_PCH” state (where PCH stands for “Paging Channel”), in which the UE can be contacted only by means of a “paging” procedure, and the location of the terminal is known at the cell level, the UE effecting radio measurements and itself effecting cell reselection on the basis of the results of those measurements and informing the network thereof by means of a cell update procedure,
a state called the “URA_PCH” state (where URA stands for “UTRAN Registration Area” and PCH stands for “Paging Channel”), in which the UE can be contacted only by means of a “paging” procedure and the location of the terminal is known at the set of cells or URA level, the UE effecting radio measurements and itself effecting cell reselection on the basis of the results of those measurements and informing the network thereof by means of a URA update procedure.

Moreover, there is provision for control of the radio measurements effected by the UE by the network (UTRAN). The UTRAN can therefore send various radio measurement control information to the UE. This information can also be transmitted by broadcasting system information and/or by transmitting a dedicated signaling message called the “Measurement Control” message.

Of the various types of radio measurement control information, there are distinguished in particular the measurement type and parameters linked to the measurement type.

The measurement types include in particular:
intra-frequency measurements (measurements effected on the same frequency as that used by the active cell or cells),
inter-frequency measurements (measurements effected on a frequency different from that used by the active cell or cells),
inter-RAT measurements, where RAT stands for “radio access technology” (or measurements effected on cells of another system, for example the GSM (Global System for Mobile communications)), using a radio access technology different from that used for the active cell or cells,
uplink traffic volume measurements,
mobile station position measurements,
etc.

The parameters linked to the measurement type include, in particular, the objects on which measurements are to be effected (e.g. cells, etc.), the criterion for reporting the results of those measurements, etc.

However, in the current version of the standard, the use of the “Measurement Control” message for measurement types other than traffic volume measurements or position measurements is in fact specified only for a UE in the Cell_DCH state.

In the current version of the standard, for a UE in a state other than the Cell_DCH state, and for measurement types other than traffic volume measurements or position measurements, control information is used that is contained in system information (“System Information Block type 11” and “System Information Block type 12”) broadcast by the network to all the UEs of the same cell. The radio measurement control information contained in this system information includes a list of cells to be measured and a parameter called the “FACH measurement occasion info” defining the measurement occasions.

As the applicant has become aware, the current version of the standard, for a UE in a state other than the Cell_DCH state, is not the optimum, or gives rise to problems, which for simplicity may be explained by means of an example.

Consider by way of example a system in which different frequencies are allocated to different types of cells, for example one frequency for cells supporting a certain function, for example the HSDPA (High Speed Downlink Packet Access) function, and another frequency for cells not supporting that function. It is considered that a UE supporting the HSDPA function in the Cell_FACH state, for example because a FACH (Forward Access CHAnnel) type transport channel is allocated to that UE for the transmission of packet type data, has a bit rate that is temporarily relatively low. In this case, if the list of cells to be measured, transmitted by means of the system information, does not contain HSDPA cells, the UE cannot reselect an HSDPA cell. In this case, if the UE then goes to the Cell_DCH state, for example because a transport channel is then allocated to that UE for the transmission of packet type data, at a bit rate that is temporarily relatively high, the UE may not be allocated an HSDSCH (High Speed Downlink Shared CHannel) type transport channel to be able to receive that data at a relatively high bit rate. The UE will have to be content with a connection on a DCH (Dedicated Channel) type transport channel having a bit rate lower than a connection on an HSDSCH type transport channel. The transfer delay may then be increased, or in other words the quality of service may be degraded, in a way that is not acceptable for the user. Conversely, if the list of cells to be measured, transmitted by means of the system information, contains HSDPA cells, a UE that does not support the HSDPA function can reselect an HSDPA cell, leading to inefficient use of resources in the system, or operation of the system that is not the optimum from the point of view of the operator.

One object of the present invention is to solve some or all of the above problems and/or to avoid some or all of the above drawbacks. More generally, an object of the present invention is to improve performance and quality of service in such systems.

One aspect of the present invention is a method for radio measurement control in a cellular mobile radio communication system, for a mobile station in connected mode and in a mobility management state in which the mobile station effects cell reselection, said method including the steps of:
reception by the mobile station of a dedicated radio measurement control message including radio measurement control information including measurement type control information, said measurement type being chosen in a group including intra-frequency measurements, inter-frequency measurements, inter-RAT (radio access technology) measurements,
configuration of the mobile station for the execution of radio measurements in accordance with the radio measurement control information received in said message,
execution of radio measurements by the mobile station in accordance with said configuration.

Another aspect of the present invention is a mobile station including means for implementing this kind of method.

A further aspect of the present invention is a mobile radio communication network entity (in particular a radio network controller (RNC)) for implementing such a method.

Other objects and features of the present invention will become apparent on reading the following description of embodiments, given with reference to the appended figures, in which:

FIG. 1 is intended to recall the general architecture of a cellular mobile radio communication system such as the UMTS in particular,

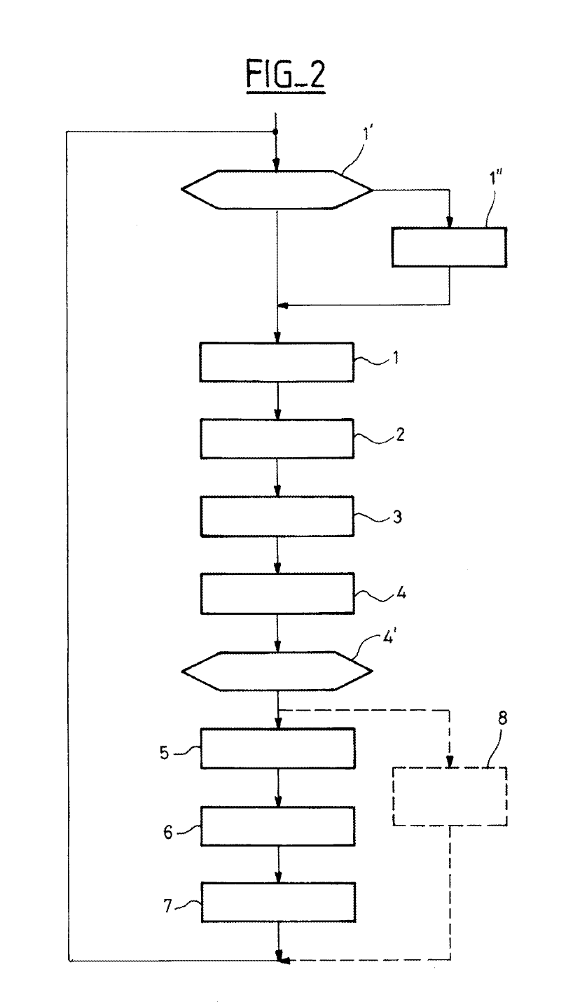

FIG. 2 is intended to illustrate one example of a method of the invention,

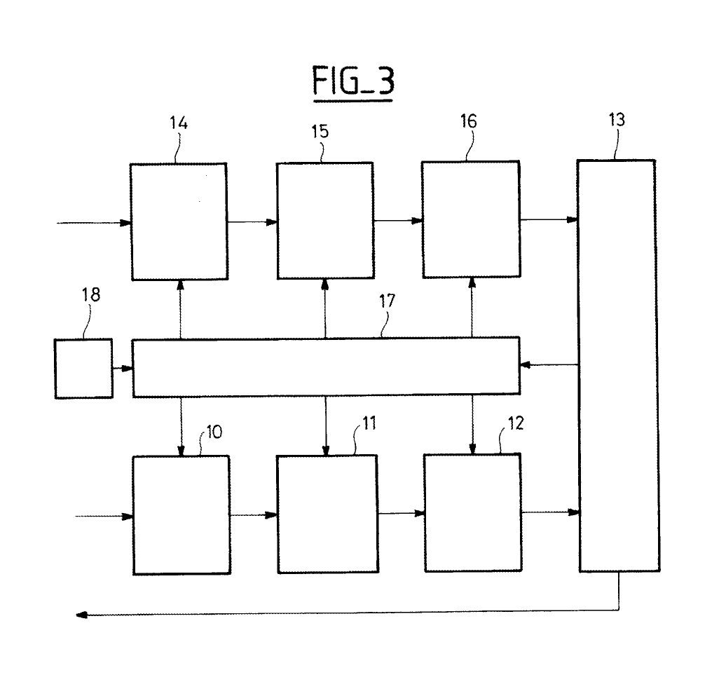

FIG. 3 is a diagram intended to illustrate one example of means that can be used in a mobile station to implement a method of the present invention.

As indicated hereinabove, the invention is applicable in particular to the UMTS; the UMTS is more particularly referred to hereinafter by way of example.

FIG. 2 shows an example of a method of the invention.

The method of the invention for radio measurement control for a mobile station in connected mode and in a mobility management state in which the mobile station effects cell reselection includes:
a step 1 of reception by the mobile station of a dedicated radio measurement control message including radio measurement control information including measurement type control information, said measurement type being chosen in a group including intra-frequency measurements, inter-frequency measurements, inter-RAT measurements,
a step 2 of configuring the mobile station to perform radio measurements in accordance with the radio measurement control information received in said message,
a step 3 of execution of radio measurements by the mobile station, in accordance with said configuration.

Said dedicated radio measurement control message corresponds in particular to the “Measurement Control” message sent to the UE by the UTRAN (to be more precise by an entity of the UTRAN corresponding to a radio network controller (RNC)) in accordance with the RRC (Radio Resource Control) protocol in the case of the UMTS.

For inter-frequency type measurements, for example, different frequencies can correspond to frequencies allocated to different types of cells, supporting different types of functions or services. For example, different frequencies can be allocated to cells supporting the HSDPA (High Speed Downlink Packet Access) function and to cells not supporting that function.

Moreover, in the example shown in FIG. 2, a preliminary step 1′ verifies that the mobile station (or UE) is in connected mode and in a mobility management state in which it effects cell reselection.

If the UE is in a mobility management state corresponding to the Cell_FACH state, steps 1, 2 and 3 can be executed directly.

If the UE is in a mobility management state corresponding to the Cell_PCH or URA_PCH state, a preliminary step 1″ of transition from the Cell_PCH or URA_PCH state to the Cell_FACH state is executed first. Such a transition can be effected in one of the following two ways in particular:
the UE initiates a cell update procedure,
the network initiates a “paging” procedure.

As pointed out in the introduction, in the Cell_FACH or Cell_PCH or URA_PCH state, the UE effects cell reselection on the basis of radio measurement results. Thus, in the FIG. 2 example, there is also shown:
a step 4 of cell reselection by the mobile station, on the basis of results of radio measurements obtained in step 3.

Moreover, for radio measurement control following cell reselection, various possibilities can be envisaged, as long as the mobile station has not received a new radio measurement control message, in the reselected new cell.

Thus in the case where a cell is reselected by the mobile station (as verified in a step denoted 4′), in a first example there may be provided:
a step 5 of reception by the mobile station of system information containing radio measurement control information,
a step 6 of configuring the mobile station to carry out radio measurements in accordance with radio measurement control information received in said system information,
a step 7 of execution of radio measurements by the mobile station, in accordance with that configuration.

According to a second example, there may be provided:
a step 8 of execution of radio measurements by the mobile station, in accordance with a configuration corresponding to control information contained in a radio measurement control message received before cell reselection.

The first example may be preferred, which is why step 8 (corresponding to the second example) is shown in dashed line in FIG. 2.

Furthermore, according to another aspect of the invention, said dedicated radio measurement control message sent by the network to a mobile station in connected mode and in a mobility management state (such as the Cell_FACH, Cell_PCH or URA_PCH state) in which the mobile station effects cell reselection, advantageously contains, compared to a dedicated radio measurement control message sent by the network to a mobile station in connected mode and in a mobility management state such as the Cell_DCH state, measurement occasion control information. This measurement occasion control information can be of the same type as the “FACH measurement occasion info” control information sent in system information, as mentioned in the introduction. Moreover, according to a further aspect of the invention, a decision is taken by the network to transmit a dedicated radio measurement control message to a mobile station in connected mode and in a mobility management state in which the mobile station effects cell reselection as a function of at least one of several criteria including in particular the type of services or functions supported by the mobile station and/or by the active cell or cells and/or by one or more cells adjacent to the active cell or cells.

In the example illustrated in FIG. 3, the mobile station includes (in addition to means that can be conventional and consequently are not described again here) for radio measurement control in connected mode and in a mobility management state in which the mobile station effects cell reselection:
means 10 for receiving a dedicated radio measurement control message,
means 11 for configuring the mobile station for the execution of radio measurements in accordance with radio measurement control information received in said dedicated radio measurement control message,
means 12 for executing radio measurements in accordance with said configuration.

The configuration means 11 can in particular include means for storing measurement control information received in said dedicated radio measurement control message, etc.

As mentioned in the introduction, the mobile station further includes means 13 for cell reselection on the basis of radio measurements effected in this way, those means sending a cell update message to the network if necessary.

Moreover, as indicated hereinabove, for radio measurement control following cell reselection, various possibilities can be envisaged, as long as the mobile station has not received a new radio measurement control message in the reselected new cell.

As shown in FIG. 3, the mobile station can thus include, in a first embodiment:
means 14 for receiving system information containing measurement control information,
means 15 for configuring the mobile station for the execution of radio measurements in accordance with the radio measurement control information received in said system information,
means 16 for execution of radio measurements in accordance with said configuration.

In a second embodiment, the mobile station can include:
means for executing radio measurements in a configuration corresponding to control information contained in a radio measurement control message received before cell reselection, which means can re-use the means 10 to 12 shown in FIG. 3.

To enable the mobile station to function in the manner described, the mobile station further includes control means 17 themselves receiving on the one hand information coming from the mobility management state management means 18 and on the other hand information coming from the cell reselection means 13.

According to another aspect of the invention, a network entity includes (in addition to means that can be conventional and consequently are not described again here), for radio measurement control in connected mode and in a mobility management state in which a mobile station effects cell reselection:
means for sending the mobile station a dedicated radio measurement control message including radio measurement control information including measurement type control information, said measurement type being chosen in a group including intra-frequency measurements, inter-frequency measurements, inter-RAT measurements, and said information including control information including measurement occasion control information.

Such a network entity corresponds in particular to a radio network controller (RNC).

According to another aspect of the invention, a network entity includes (in addition to means that can be conventional and consequently are not described again here):
means for deciding to send a dedicated radio measurement control message to a mobile station in connected mode and in a mobility management state in which a mobile station effects cell reselection, as a function of at least one of a plurality of criteria including in particular the type of services or functions supported by the mobile station and/or by the active cell or cells and/or by one or more cells adjacent to the active cell or cells.

The particular implementation of the various means described representing no particular problem for the person skilled in the art, those means do not need to be described here in more detail than by stating their function, as has been done hereinabove.

1. Method for radio measurement control in a cellular mobile radio communication system, for a mobile station in connected mode and in a mobility management state in which the mobile station effects cell reselection, said method including the steps of:
reception (1) by the mobile station of a dedicated radio measurement control message including radio measurement control information including measurement type control information, said measurement type being chosen in a group including intra-frequency measurements, inter-frequency measurements, inter-RAT (radio access technology) measurements,
configuration (2) of the mobile station for the execution of radio measurements in accordance with the radio measurement control information received in said message,
execution (3) of radio measurements by the mobile station in accordance with said configuration.

2. Method according to claim 1, wherein said mobility management state in which the mobile station effects cell reselection corresponds to the Cell_FACH state as defined in the RRC (Radio Resource Control) protocol for the UMTS system.

3. Method according to claim 1, wherein, said mobility management state in which the mobile station effects cell reselection corresponding to the Cell_PCH or URA_PCH state as defined in the RRC (Radio Resource Control) protocol for the UMTS system, said method includes a preliminary step of transition from the Cell_PCH or URA_PCH state to the Cell_FACH state as defined in the RRC (Radio Resource Control) protocol for the UMTS system.

4. Method according to claim 1, including, for the case of cell reselection and before reception of a dedicated radio measurement control message in the reselected new cell, steps of:
reception (5) by the mobile station of system information containing radio measurement control information,
configuration (6) of the mobile station for the execution of radio measurements in accordance with the radio measurement control information received in said system information,
execution (7) of radio measurements by the mobile station in accordance with that configuration.

5. Method according to claim 1, including, for the case of cell reselection and before reception of a dedicated radio measurement control message in the reselected new cell, steps of:
execution (8) of radio measurements by the mobile station in accordance with a configuration corresponding to control information received in a radio measurement control message received before said cell reselection.

6. Method according to claim 1, wherein, for inter-frequency type measurements, different frequencies correspond to frequencies allocated to different types of cells supporting different types of services or functions.

7. Method according to claim 6, wherein different frequencies are allocated to cells supporting the HSDPA (High Speed Downlink Packet Access) function and to cells not supporting that function.

8. Method according to claim 1, further including a step of:
transmission by the network to said mobile station, in said dedicated radio measurement control message, of measurement occasion control information.

9. Method according to claim 1, further including a step of:
decision by the network to transmit said message to the mobile station, as a function of at least one of a plurality of criteria including the type of services or functions supported by the mobile station and/or by the active cell or cells and/or by one or more cells adjacent to the active cell or cells.

10. Mobile station, including, for radio measurement control in a mobile radio communication system, in connected mode and in a mobility management state in which the mobile station effects cell reselection:
means (10) for receiving a dedicated radio measurement control message,
means (11) for configuring the mobile station for the execution of radio measurements in accordance with radio measurement control information received in said dedicated radio measurement control message,
means (12) for execution of radio measurements in accordance with said configuration.

11. Mobile station according to claim 10, including, for the case of cell reselection and before reception of a dedicated radio measurement control message in the reselected new cell:
means (14) for receiving system information containing radio measurement control information,
means (15) for configuring the mobile station for the execution of radio measurements in accordance with the radio measurement control information received in said system information,
means (16) for execution of the radio measurements in accordance with said configuration.

12. Mobile station according to claim 10, including, for the case of cell reselection and before reception of a dedicated radio measurement control message in the reselected new cell:
means (10, 11, 12) for, before reception of a dedicated radio measurement control message in a reselected new cell, execution of radio measurements in accordance with a configuration corresponding to control information contained in a radio measurement control message received before cell reselection.

13. Mobile radio communication network entity including, for the control of radio measurements in a mobile radio communication system, in connected mode and in a mobility management state in which a mobile station effects cell reselection:
means for transmitting to said mobile station a dedicated radio measurement control message including radio measurement control information including measurement type control information, said measurement type being chosen in a group including intra-frequency measurements, inter-frequency measurements, inter-RAT (radio access technology) measurements, and said information including control information including measurement occasion control information.

14. Mobile radio communication network entity, including, for the control of radio measurements in a mobile radio communication system, in connected mode and in a mobility management state in which a mobile station effects cell reselection:
means for deciding to transmit to said mobile station a dedicated radio measurement control message, as a function of at least one of a plurality of criteria including in particular the type of services or functions supported by the mobile station and/or by the active cell or cells and/or by one or more cells adjacent to the active cell or cells.
